(19) United States
(12) Patent Application Publication
(10) Pub. No.: US 2007/0293270 A1
(43) Pub. Date: Dec. 20, 2007

(54) Voice acceptance of incoming call without voice recognition

(76) Inventors: Franco Montebovi, Lund (SE); John Hard, Malmoe (SE)

Correspondence Address: PERMAN & GREEN, 425 POST ROAD, FAIRFIELD, CT, 06824, US

(21) Appl. No.: 11/471,026

(22) Filed: Jun. 20, 2006

(51) Int. Cl. H04M 1/00; H04M 1/24

(52) U.S. Cl. 455/563; 381/56; 455/550.1

(57) ABSTRACT

A communication device and method is described in which ambient sound is monitored and a threshold sound level is set. Acceptance of a call may be actuated by voice input that exceeds the ambient sound threshold. The detection of a sound peak will trigger a communication connection and initiate the call without the need for voice recognition.

### FIELD OF INVENTION

The embodiments disclosed herein genrally relate to the field of telephone communication in general and particularly mobile communications. More specifically the aspects of the invention relates to methods and systems for facilitating the hands free operation of a communications device.

### TECHNICAL BACKGROUND

A user interface for a communications device generally comprises a set of buttons, joystick, keyboard, keypad, microphone or other similar means by which the user can enter data and commands into the communications device. In addition a display screen, speaker and other similar means provide feedback to the user from the communications device. These devices further include, a microprocessor control unit that provide the means for processing entered data and directing operation, and a communication unit including a transceiver and associated electronic circuitry by which the communications device is able to communicate with other communications devices. These functions are controlled by a software operating system stored in the microprocessor

A telephones and communication devices of this basic kind are well-known in the art and there is no need for any detailed description.

As soon as the mobile communications device is turned on, the operating system of the mobile communications device starts running. The operating system handles e.g. the interaction between the display unit, the input unit, and the communications unit. The operating system also handles other kinds of applications, such as a contact management application, a calendar application, a settings application for setting the behaviour of the phone and its operating system, a web application, and other application that may be provided.

Since such communication devices, in particular mobile devices that operate on a cellular network, have become a full time part of many life styles, these devices may be used at anytime and place. Increasing attention, therefore, has been given to providing hands free operation in order to minimize the interruptions that might otherwise occur. With advances made in the field of voice recognition, efforts have been made to incorporate voice recognition into communication devices, in particular to enhance the hands free mode of operation.

Examples of such systems are described in U.S. Pat. Nos. 6,212,408; 6,836,651 and 6,240,303. In the '303 patent, it is an object to replace the keypad of mobile communication devices with a voice recognition system and provides a prominent button with which to activate voice recognition. Once the voice actuation system is activated, commands such as “dial, call, answer,” may be used to operate the communication device. These systems require a voice recognition engine that is able to recognize, interpret, and act on the user's voice. These are inherently complex and software heavy operations that require considerable processing capability to be built into the communication device.

A review of the use of hands free systems, seems to indicate that the most critical time for their use is when an incoming call is received and the need to accept the call arises. It is an object of the embodiments described in this application to provide a means for accepting an incoming call by voice while avoiding the need for voice recognition.

### SUMMARY OF THE INVENTION

It is an object of the invention to address the above discussed problems. This has, in accordance with the invention, been achieved by a method in a communications device and by a communications device.

In accordance with one aspect of the invention a method is described for use in a mobile or other communications device in which the ambient sound is monitored and a threshold sound level is measured. Acceptance of a call may be actuated by a voice input that significantly exceeds the ambient sound level. The detection of a significant sound peak will trigger a communication connection and initiate the call.

In another aspect of the invention, the user may speak a greeting that is buffered in the phone and used to start the call. In this manner the user may just start talking as the communication device signals an incoming call and a conversation can immediately ensue.

In another aspect of the invention, a mobile communications device is constructed having a control unit, a display unit, a communication unit and an input unit that includes a microphone. A sensor is connected to receive incoming signals from the microphone and measure the ambient sound level. The measured sound level is stored and used to determine a threshold that is indicative of a voice input. A sound processing component is actuated upon the receipt of an incoming call to compare peaks in the received sound with the ambient sound level threshold. The processing component causes the communication unit to accept a call when the peaks exceed the predetermine threshold.

In another aspect of the invention a mobile communications device having a control unit, a display unit, an input unit, and a communications unit is further provided with a software module that causes a call to be accepted upon sensing a voice input.

### BRIEF DESCRIPTION OF THE DRAWINGS

The invention will by way of example be described in more detail with reference to the appended schematic drawings, which shows an embodiment of the invention.

FIG. 1 is a schematic block diagram of the basic components of a mobile communications device and system;

FIG. 2 is a plan view of a mobile communication device, as used in the system of FIG. 1;

FIG. 3 is a graph of input sound signals; and

FIG. 4 is a block diagram of an embodiment of the method of this application

### DETAILED DESCRIPTION OF PREFERRED EMBODIMENTS

A mobile communication device 1, is an example of a cellular telephone incorporating features of the present invention, such features being illustrated in the figures. Although the aspects of the invention will be described with reference to the embodiments shown in the drawings, it should be understood that the invention may have many alternate forms and may be used in a wide variety of communication devices. In addition, any suitable size, shape, type or combination of elements or materials could be used.

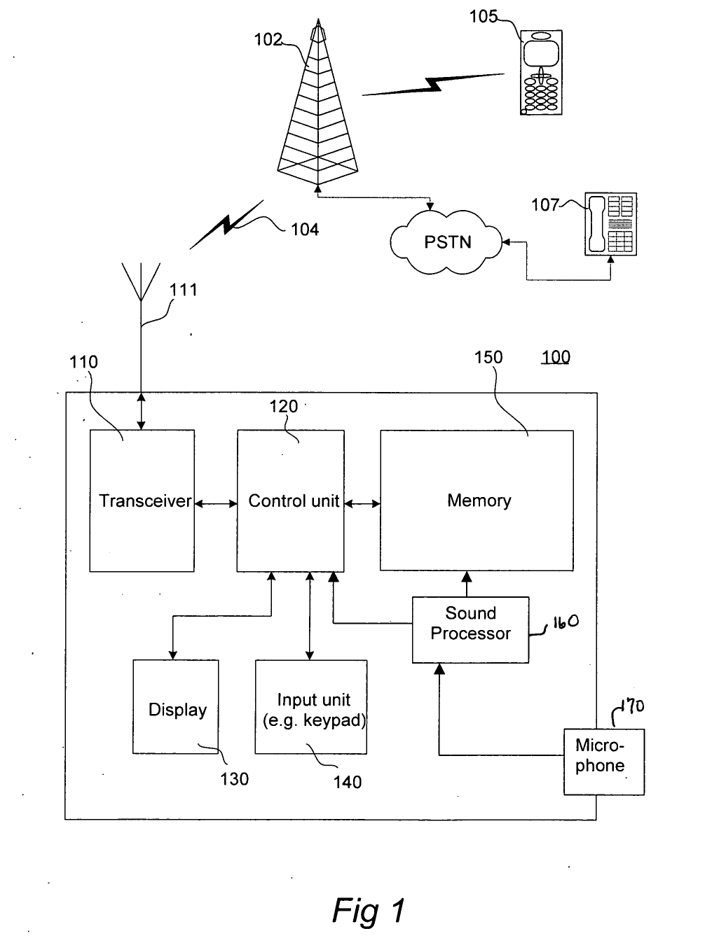

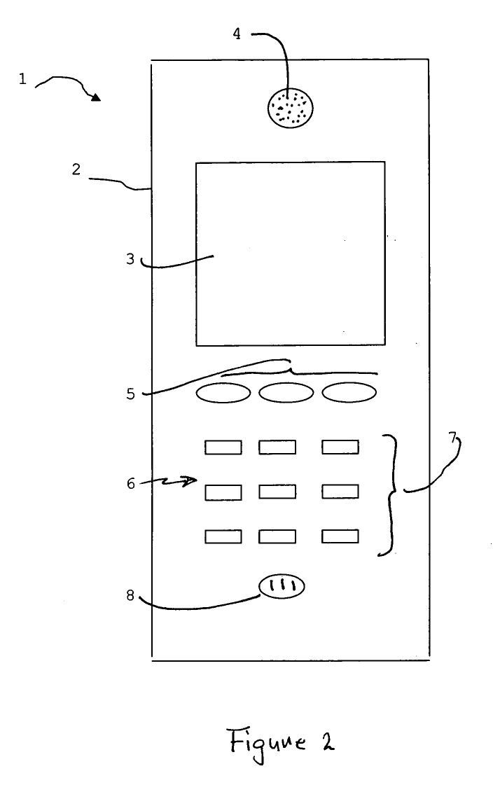

FIG. 1 is a schematic block diagram of a mobile telecommunication terminal 100 according to one embodiment. This system and the mobile communication terminal of FIG. 2 are used for ease of illustrating the present invention and such illustrations are not intended to limit the claims herein. A communication unit consisting of a transceiver 110 is used for communicating with a base station 102 via an antenna 111. The base station 102 is in communication with other mobile telecommunication terminals 105 via a mobile communications network, and stationary terminals 107 via e.g. a public switched telephone network (PSTN).

Within mobile communication device 100, a control unit 120 is coupled to the transceiver 110. The control unit 120 may comprise signal processing circuitry in order to process e.g. voice data and message data (e.g. SMS or MMS) from a user of the mobile telecommunication terminal 100 and provide the transceiver 110 with the processed data for transmission to the base station 102. Likewise, the control unit 120 may comprise signal processing circuitry for processing data received from the other telecommunication terminals 105, 107 in order to provide the user of the mobile telecommunication terminal 100 with e.g. audio, image, video or message data. Alternatively (not shown) some or all of the signal processing functionality may be provided by specialized circuitry in the mobile telecommunication terminal 100.

The control unit 120 is coupled to a display 130 for providing a user of the mobile telecommunication terminal 100 with visual data regarding e.g. a specific call in progress, telecommunication numbers stored in the mobile telecommunication terminal 100, signal strength of the wireless communication link 104, messages received from other mobile telecommunication terminals, etc.

The control unit 120 is moreover coupled to an input unit 140, which may be in the form of a keyboard/keypad; an on-screen touch-sensitive keyboard; a navigation wheel or joystick for scrolling and selecting items, digits and/or characters shown on the display 120; and a microphone for receiving sound signals such as voice.

A sound processor 160 is connected to receive signals received by microphone 170 and measure ambient noise level. The ambient noise level is used to determine a threshold that may be stored in memory 150. The threshold is set so that it may be compared with noise spikes detected by microphone 170. Noise spikes that exceed the threshold generally indicate voice input. The function of sound processor 160 is triggered by the device 1 receiving an incoming call and is disabled when the call is terminated. Sound processor 160 may be a separate software module resident in memory 150 and executed by control unit 120, a stand alone module connected to the associated components or some other sub-combination of components that may be advantageous in a particular application.

A memory 150 is connected to the control unit 120. The memory 150 may be a single memory or many different memories implemented on different chips, alone or together with other electronic circuitry, by means of different technologies (such as RAM, ROM, EPROM, EEPROM, Flash, etc) which all are accessible by the control unit 120.

An illustrative embodiment of a mobile communications device 1 is depicted in FIG. 2 having the general construction of a mobile telephone 1. A mobile telephone is used for illustration only as emodiments of this invention can take a variety of forms in a wide assortment of communication devices. Mobile telephone 1 has a housing 2 for enclosing the operating components of the device as shown in FIG. 1. An input unit is provided such as keypad 6 having a typical arrangement of keys 7. Buttons 5 may be used for a variety of functions such as on/off and other tasks. The input unit further includes microphone 8 (170 in FIG. 1) located on the device 1 positioned advantageously to receive voice input from the user. A display screen 3 is also provided as well as a speaker 4.

As soon as the mobile communications device 1 is turned on, an operating system of the mobile communications device starts running. The operating system handles e.g. the interaction between the display unit, the input unit, and the communications unit.

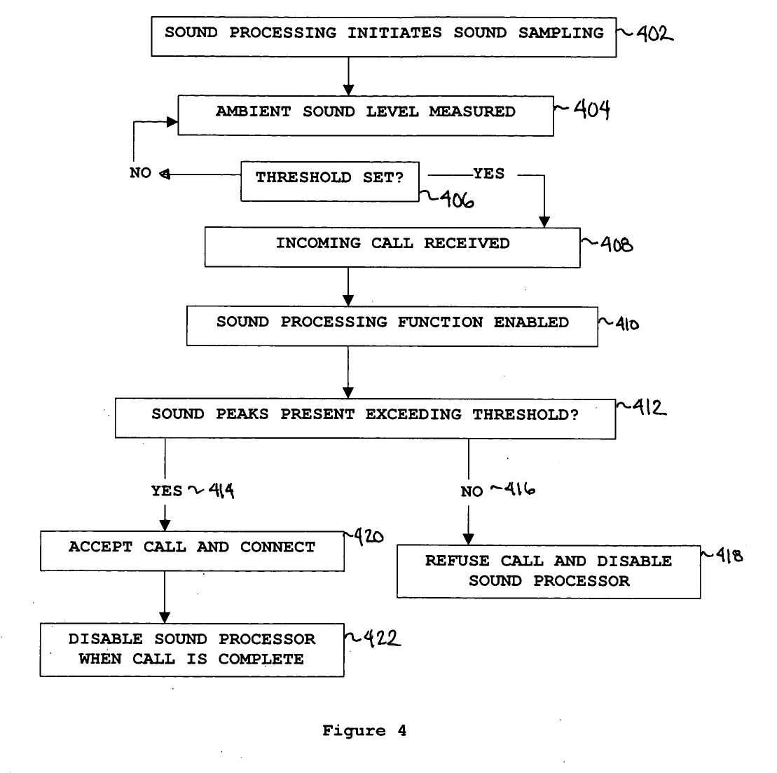

As shown in the process diagram of FIG. 4, the operating system may cause the control unit 120 to periodically sample 402 sound input from the microphone. The sampling process is designed to measure 404 ambient noise level and establish a voice threshold calculated to indicate a voice input when exceeded. Initially, a predetermined threshold may set 406 until it us updated by the sampling procedure. Once the threshold is determined, the phone is ready to accept calls through the hands free process. When a signal is received 408 by the communication unit indicating an incoming call, the operating system causes the control unit 120 to begin 410 processing sound signals from microphone 170. If the user responds by speaking, noise spikes or peaks will occur and are compared to the set threshold. If the spikes exceed 412 the threshold, the operating system will prompt the control unit 120 to accept 420 the call and complete the connection. To avoid continuous cycling of the sound processor, the sound processing may be disabled 422 after a call is completed. The periodic sampling would continue to update the noise threshold for future use. If no peaks occur, i.e. the user does not chose to answer, the called is refused 418 and the sound processor is disabled.

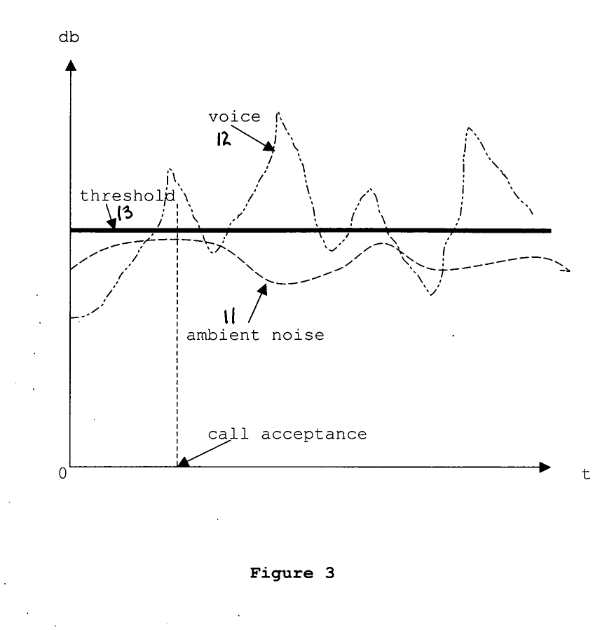

An example of a noise pattern received by the sound processor 160 is shown in FIG. 3 in which curve 11 represents ambient noise. Curve 13 represents a threshold based on curve 11. Curve 12 represents a voice input and indicates a point at which a call acceptance may be made.

An alternate embodiment may be set up to record and buffer the voice input that causes call acceptance. After connection the greeting will be replayed. This permits the user to answer the call with a greeting and immediately start the conversation.

In this manner a hands free system can be initiated conveniently without interruption in any circumstances for example, while driving a car. The use of a speaker phone that transmits through speaker or through a headset will complete the hands free user interface without the complexities of voice recognition.

It should be understood that the above description is only illustrative of the invention. Various alternatives and modifications can be devised by those skilled in the art with out departing from the invention. Accordingly, the disclosed embodiments are intended to embrace all such alternatives, modifications and variances which fall with the scope of the appended claims.

What is claimed is:

1. In a communications device, a method for a hands free acceptance of an incoming call comprising:
sensing ambient noise;
setting an ambient noise threshold based on said sensed ambient noise;
receiving an incoming call;
monitoring ambient noise to obtain noise level spikes;
comparing said noise level spikes to the ambient noise threshold;
accepting the incoming call when said received noise level spikes exceed the ambient noise threshold; and
refusing the incoming call is no noise level spikes are obtained that exceed the ambient noise threshold.

2. The method according to claim 1 wherein the ambient noise threshold is set so that noise level spikes that exceed said threshold are indicative of voice input.

3. The method according to claim 2 wherein said voice input is buffered and replayed after the call is accepted.

4. The method according to claim 1, wherein the monitoring, comparing and accepting are enabled by the incoming call and disabled when the call is ended.

5. The method according to claim 1, wherein ambient sound level is sensed by periodic sampling of the output of a microphone connected as part of the communication device.

6. A communication device comprising:
a control unit, a communication unit and an input unit, wherein the input unit includes a microphone for picking up ambient sound and voice input;
a sound processor that is connected to receive sound signals from the microphone and is constructed to set an ambient noise level threshold based on the received sound signals;
an acceptance module constructed to process the sound signals after an incoming call is received be comparing said after call sound signals to the ambient noise threshold; said acceptance module connected to the control unit to cause the control unit to accept an incoming call if the level of said after call sound signals exceed the ambient noise threshold.

7. The communication device according to claim 6, wherein the sound processor sets the ambient noise threshold so that noise level spikes that exceed said threshold are indicative of voice input.

8. The communication device according to claim 7, wherein the sound processor buffers the voice input and relays the voice input after the call is accepted.

9. The communication device according to claim 6, wherein the acceptance module is enabled by the incoming call and disabled when the call is ended.

10. The communication device according to claims 6, wherein the sound processor is constructed to periodically sample the output of the microphone in order to set the ambient noise threshold.

11. The communication device according to claim 6, wherein the acceptance module is constructed as an element of the sound processor.

12. The communication device according to claim 6, wherein the communication device is a mobile telephone.

13. A program product for use in a communication device having a processor, said program product comprising:
processor readable program code for causing said processor to:
sense ambient noise;
set an ambient noise threshold based on said sensed ambient noise;
receive an incoming call;
monitor ambient noise to obtain noise level spikes;
compare said noise level spikes to the ambient noise threshold;
accept the incoming call when said received noise level spikes exceed the ambient noise threshold; and
refuse the incoming call if no noise level spikes are obtained that exceed the ambient noise threshold.

14. The program product according to claim 13, wherein the program code causes the processor to set ambient noise threshold so that noise level spikes that exceed said threshold are indicative of voice input.

15. The program product according to claim 14, wherein program code causes the processor to buffer voice input and replay the voice input after the call is accepted.

16. The program product according to claim 13, wherein the program code causes the processor to enable monitoring, comparing and accepting when the incoming call is received.

17. The method according to claim 13, wherein the program code causes the processor to sense the ambient sound level by periodic sampling of the output of a microphone connected as part of the communication device.
